(19) United States
(12) Patent Application Publication
(10) Pub. No.: US 2022/0082092 A1
(43) Pub. Date: Mar. 17, 2022

(54) Method for Operating a Liquid Air Energy Storage

(71) Applicant: Stanislav Sinatov, Kiryat-Ono (IL)

(72) Inventor: Stanislav Sinatov, Kiryat Ono (IL)

(73) Assignee: Newpolygen Technologies Ltd., Kiryat-Ono (IL)

(21) Appl. No.: 17/352,800

(22) Filed: Jun. 21, 2021

Related U.S. Application Data
(60) Provisional application No. 63/076,954, filed on Sep. 11, 2020.

(51) Int. Cl. F03G 7/06; F17C 9/04; F25J 1/00

(52) U.S. Cl. CPC F03G 7/06; F17C 9/04; F25J 1/0012; F17C 2270/0581; F17C 2221/033; F17C 2265/07; F17C 2221/031

(57) ABSTRACT

A method for operating the liquid air energy storage (LAES) includes production of the storable liquid air through consumption of a low-demand power and recovery the liquid air for co-production of an on-demand power and a high-grade saleable cold thermal energy which may be used, say, for liquefaction of the delivered natural gas; in so doing zero carbon footprint is provided both for fueled augmentation of the LAES power output and for LNG co-production at the LAES facility.

### CROSS-REFERENCE TO RELATED APPLICATIONS

This application claims the benefits of U.S. Provisional Application No. 63/076,954 filed on Sep. 11, 2020.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF INVENTION

The present invention relates to the field of energy conversion technique, and more specifically to the methods enabling an improvement in the technologies intended for conversion and storage of excessive energy in the electric grids. More particularly, the present invention relates to the methods making possible to provide a highly efficient fueled power output augmentation of the liquid air energy storage output simultaneously with zero carbon emissions of the storage exhaust and effective recovery of a high-grade waste cold thermal energy for co-production of the liquefied natural gas at the energy storage facility.

### BACKGROUND OF THE INVENTION

In modern times the electrical energy storages are becoming an integral part of the distribution grids, ensuring the on-demand and reliable supply of electricity by the intermittent renewable energy sources (wind, solar) and providing a stable and efficient operation of the base-load fossil fuel-fired and nuclear power plants around the clock.

Amongst the known methods for energy storage able to accumulate a lot of excessive energy and store it over a long time-period, the recently proposed methods for Liquid Air Energy Storage (LAES) (see e.g. Pat. FR 2,489,411, U.S. Pat. Nos. 9,217,423, 9,638,068, et al.) are distinguished by a much simpler permitting process and the freedom from any geographical, land and environmental constraints, inherent in other known methods for large-scale energy storage technologies, like Pumped Hydro Electric Storage (PHES) and Compressed Air Energy Storage (CAES). In the LAES systems the air is compressed using excessive power from the renewable energy sources or the grid, deeply cooled, liquefied and stored during off-peak hours, and thereafter it is pumped, re-gasified, further heated and used as effective working medium for producing a peaking power in the periods of high demand for power. With the same duration of discharging and charging the LAES facility, a round-trip efficiency (RTE) of this facility may be determined as a simple relationship between the power produced by the facility during discharging and power consumed during facility charging. Considering a high energy intensity of the liquid air production during off-peak hours, many technical solutions have been proposed to improve the round-trip efficiency of LAES facility both through reducing the power consumed in air liquefaction and through increasing the energy released during LAES discharge.

For these purposes, an internal recovery of the waste heat and cold thermal energy streams may be used, as proposed, for example, in the U.S. Pat. Nos. 9,217,423, 9,638,068, 10,012,447, 10,138,810 and 10,550,732, as well as in the Pat. App. US 2015/0192358, US 2017/0016577 and WO 2019/158921. Here a cold thermal energy released during liquid air regasification is stored and further used to reduce the energy consumed in air liquefaction. On the other hand, a compression heat extracted from the air being liquefied is stored and further used to preheat the discharged air prior to and in the process of its expansion at the LAES facility. At least two limitations are inherent in the internal recovery of the waste heat and cold thermal energy at the LAES facility: bulky, complicated and expensive design of the cold and heat thermal storages and a relatively moderate RTE value, which may be achieved in this manner.

A significant simplification of the LAES facility configuration and some increase in its RTE value may be provided through a co-location of this facility with the power generation or industrial plants. For example, recovering the waste energy streams from the natural gas pressure reduction (city gate) stations (see e.g. U.S. Pat. No. 10,655,913) or the waste cold thermal energy streams from the liquefied natural gas (LNG) regasification terminals (see e.g. US Pat. App. 2016/0047597, U.S. Pat. Nos. 10,767,515 and 10,731,795) makes possible to drastically reduce an energy intensity of the air liquefaction at the LAES facility. Recovering the exhaust waste heat streams from the co-located industrial or power generation may be used not only to markedly increase an energy release during LAES facility discharge (see e.g., U.S. Pat. Nos. 10,662,821, 10,655,913 and US Pat. App. 2019/0353056), but to reduce a power consumed in air liquefaction as well (see e.g. U.S. Pat. No. 10,571,188). However, some limitations are also inherent in recovering the waste energy streams from the co-located industrial and power plants at the LAES facility: a rare possibility for such co-location, the difficulties in fitting the operation regime of the LAES facility to one of the co-located plant, et al.

Therefore burning a fossil fuel for an increase in discharge air temperature prior to and in the process of air expansion at the LAES facility is proposed as a more accessible way for augmenting the LAES output on frequent occasions. Two groups of the technical solutions have been developed for this purpose. The solutions of the first group are characterized by integration of the indirect-fired heater with the industrial expander(s) and described e.g. in the US Pat. App. 2018/066,888. In the solutions of the second group the discharged air is either preheated in the direct-fired heater upstream of the industrial expander(s) (see e.g. U.S. Pat. No. 8,063,511) or used as oxidant at the co-located fueled internal combustion engine (ICE)-based power plant. In the U.S. Pat. No. 6,920,759, U.S. Pat. App. 2005/0126176 and 2015/0192065 a gas turbine prime mover is used as such ICE. However, an excessively high specific air consumption is typical for the gas turbine prime mover. This air consumption exceeds that typical for the comparable in power reciprocating internal combustion engine by a factor 2-3, resulting in the attendant increase in an installed capacity of compressor train and in a required volume of liquid air tank at the LAES facility. Thus, in the U.S. Pat. Nos. 10,655,913, 10,731,795, 10,767,515, et al. a supercharged reciprocating gas engine is proposed as the alternative fueled ICE prime mover, making possible to further improve the LAES performances.

At the same time in all mentioned proposals for fueled augmentations of the facility output, a storage of “green” electricity from renewable energy sources is found to be technologically connected with releasing the harmful carbon dioxide emissions (CO₂) inherent in the LAES exhaust. This sends the developers in search of the ways for effective post-combustion capture of the carbon dioxide generated in the process of fuel combustion at the LAES facility. One of such technical solutions is described in the U.S. Pat. No. 10,940,424. Here a cold thermal energy of the discharged liquid air at the LAES facility is recovered for deep cooling of the exhaust stream from the supercharged reciprocating gas engine used for fueled augmentation of the LAES discharge power output. This results in re-gasification of the liquid air and cryogenic capture of the CO₂ components from exhaust of the LAES facility. A mentioned technical solution provides a zero-carbon emitting basis for operation of the LAES facility with fueled power augmentation, but precludes from using a cold thermal energy of the re-gasified liquid air for other purposes.

Among these purposes, an increase in the RTE of LAES facility may be named above all. One of the suitable solutions already described above consists in storing a cold thermal energy of the discharged air and internal recovering a stored energy for reducing a power consumed for air liquefaction during charging the LAES facility. An alternative approach is described in the Pat. App. US2018/0066888 and Pat. U.S. Pat. No. 10,767,515, wherein a cold thermal energy of the discharged air is externally recovered for liquefaction or re-liquefaction of natural gas, resulting in co-production of the liquefied natural gas (LNG) and peaking power during discharging the LAES facility. Finally, a mixed approach to recovering a cold thermal energy of the discharged air is described in the presentation of the European R&TD “CryoHub” project. Here one part of cold energy at a lower temperature is recovered internally, whereas another part of this energy at a higher temperature is recovered externally at the co-located refrigerated warehouses and food factories. All above-identified technical solutions provide a significant increase in the RTE of LAES facility through recovering a cold thermal energy of the discharged air, but preclude from a cryogenic capture of the CO₂ emissions from facility exhaust.

By this means there are a need for such method for operation of the LAES facility with fueled augmentation of the on-demand power output, which could provide a zero-carbon footprint for this operation and wherein an external recovery of the exhaust waste energy and cold thermal energy of the discharged air could provide the demands of co-located industrial facilities for a high-grade cold energy without consumption of the on-peak power by this facilities. The target method may provide, for example, a decarbonized exhaust from the LAES facility and co-production of the on-demand power and liquefied natural gas (LNG) at the LAES facility for the co-located natural gas liquefaction plant.

### SUMMARY OF THE INVENTION

In one or more embodiments, a proposed method for operating a liquid air energy storage (LAES) may comprise in combination: a) charging the LAES with a liquid air produced through consuming a low-demand power from a co-located renewable energy source or a grid and storing the liquid air in a storage tank; b) delivering a natural gas (NG) into the LAES; c) discharging the LAES with producing an on-demand power output through pumping, re-gasifying, heating, expanding and recovering a stored air as an oxidant for a burning of a minor part of said delivered NG in a fueled prime mover being used for augmentation of the LAES on-demand power output and selected from a group consisting of, but not limited to an industrial rotating expander and a turbocharged reciprocating internal combustion engine (RICE); and d) partial recovering a waste energy of a primer mover's exhaust and a cold thermal energy of the stored air for dehydrating said fueled prime mover's exhaust and cryogenic capturing a carbon dioxide (CO₂) component formed by the NG burning in said fueled prime mover, resulting in removing said captured CO₂ component from a dehydrated exhaust of the fueled prime mover.

The invented method may differ from the known those in that: a) recovering the remainder of the waste energy of the fueled prime mover's exhaust and the cold thermal energy of the stored air is performed for liquefying a most part of the NG delivered into the LAES and harnessing a resulting liquefied NG (LNG) as a saleable co-product of said LAES; b) a production rate of said LNG is dependent on a type of the fueled prime mover and is increased through selecting the industrial rotating expander, as said fueled prime mover, all other factors being equal; and c) a value of said LAES on-demand power output is dependent on the type of the fueled prime mover and is increased through selecting the turbocharged RICE, as said fueled prime mover, all other factors being equal.

In one or more embodiments, the invented method may further comprise the following consecutive processes in a stream of the stored air during discharging the LAES: a) pumping the liquid air from the storage tank, resulting in formation of a high-pressure (HP) liquid air; b) heating the HP liquid air by a depressurized exhaust from a low-pressure (LP) exhaust expander, resulting in forming a HP re-gasified air; c) heating the HP re-gasified air by a LP exhaust from the fueled prime mover; d) work-performing partial expanding the HP re-gasified air in a HP air expander, resulting in producing a first part of the LAES on-demand power output and in forming a medium-pressure (MP) re-gasified air at the outlet of the HP air expander; and e) recovering the LP re-gasified air in the fueled prime mover for oxidizing 5-15% of the delivered NG in said fueled prime mover, resulting in producing a second part of the LAES on-demand power output by the fueled prime mover and releasing a stream of the LP exhaust from said fueled prime mover.

In one or more embodiments, the invented method may further comprise the following consecutive processes in the stream of the LP exhaust from the fueled prime mover during discharging the LAES: a) cooling said LP exhaust from the fueled prime mover by the HP re-gasified air, resulting in condensing and freezing a water (H₂O) component and forming a dehydrated LP exhaust; b) work-performing expanding the dehydrated LP exhaust in the LP exhaust expander, resulting in further cooling the depressurized exhaust and producing a third part of the LAES on-demand power output; c) final deep cooling the depressurized exhaust from the LP exhaust expander by the HP liquid air, resulting in de-sublimating and separating the CO₂ component from the depressurized exhaust and forming a deeply cooled decarbonized LAES exhaust; d) pressurizing, fusing and pumping the separated CO₂ component; e) recovering a cold thermal energy of the separated CO₂ component for pre-cooling 85-95% of the NG delivered into the LAES; and f) recovering a cold thermal energy of said decarbonized LAES exhaust for liquefying a pre-cooled 85-95% of the NG delivered into the LAES and forming the LNG co-product of the LAES.

In one or more embodiments, said de-sublimating the CO₂ component may provide reducing its content in the depressurized exhaust from the LP exhaust expander at least by 98.5%.

In one or more embodiments, the invented method may further comprise the following consecutive processes for co-producing the LNG at the LAES: a) supplying a NG pre-treatment unit with 85-95% of the NG delivered into the LAES; b) removing the potentially freezable components from the supplied NG in the pre-treatment unit and following compressing said supplied NG up to a selected high pressure (HP), resulting in forming a HP treated NG stream; c) recovering the cold thermal energy of the CO₂ component separated from the depressurized exhaust for pre-cooling said HP treated NG stream, resulting in forming a HP pre-cooled NG stream; d) recovering the cold thermal energy of the decarbonized LAES exhaust for liquefying the HP pre-cooled NG stream, resulting in forming a HP liquefied NG stream; and e) expanding the HP liquefied NG stream, resulting in forming a LP LNG, as the LAES co-product, at a rate of 0.5-1.7 ton/h per each MW of the LAES on-demand power output, depending on the type of the fueled prime mover selected for installation at the LAES.

In one or more embodiments of the invented method, removing the potentially freezable components from the NG intended for liquefying at the LAES may be performed in the pre-treatment unit built into a NG liquefaction plant co-located with the LAES.

Finally, in one or more embodiments of the invented method, at least a part of the LAES on-demand power output during its discharging may be used for operating the co-located NG liquefaction plant, whereas the LNG co-produced at the LAES is used for increase in a production yield of said co-located NG liquefaction plant.

### BRIEF DESCRIPTION OF THE DRAWINGS

Embodiments will hereinafter be described in detail below with reference to the accompanying drawings, wherein lie reference numerals represent like elements. The accompanying drawings have not necessarily been drawn to scale. Where applicable, some features may not be illustrated to assist in the description of underlying features.

FIG. 1 is a schematic view of the first embodiment showing an invented interplay of the facilities, equipment, and utilities used for operation of the Liquid Air Energy Storage (LAES), according to the invented method.

FIG. 2 is a schematic view of the second embodiment for charging the LAES facility with use of two booster compressor-loaded turboexpanders.

FIG. 3 is a schematic view of the third embodiment for discharging the LAES facility equipped with the fueled supercharged reciprocating internal combustion engine (RICE) and co-producing the liquefied natural gas (LNG), according to the invented method.

FIG. 4 is a schematic view of the fourth embodiment for discharging the LAES facility equipped with the fueled industrial rotating expander and co-producing the liquefied natural gas (LNG), according to the invented method.

### DETAILED DESCRIPTION OF THE INVENTION

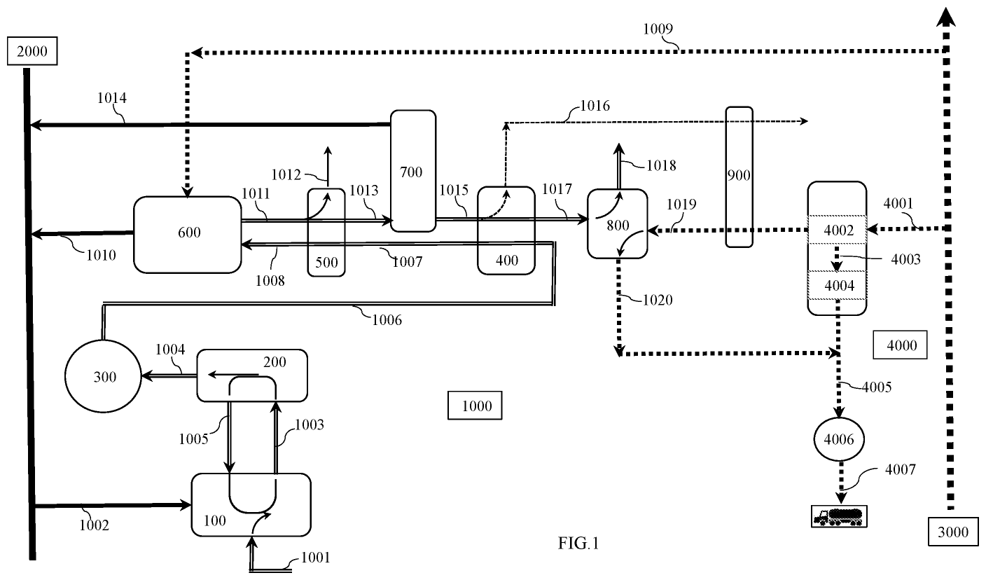

The practical realization of the invented method for operating the LAES facility may be performed through interaction between all the involved equipment packages and utilities, schematically shown in the FIG. 1. Here the facilities, equipment packages and utilities are designated as 1000—a proper LAES facility, 2000—an electrical grid, 3000—a pressurized natural gas (NG) main pipeline, and 4000—a co-located liquefied NG (LNG) production plant. The LAES facility 1000—comprises the following equipment packages: 100—air compression and pre-treatment package, 200—air auto-refrigeration and liquefaction package, 300—liquid air storage and pumping package, 400—LAES exhaust decarbonization package, 500—LAES exhaust dehydration package, 600—discharged air recovery package, 700—cold exhaust expander package, 800—NG liquefaction package, and 900—NG pre-cooling package. In the absence of the co-located LNG production plant, the package 800 is additionally equipped with its own NG pre-treatment unit which is acting as a similar unit 4002 in the package 4000. The interaction of all mentioned elements goes on as follows.

During charging the LAES a stream of atmospheric air is delivered through the pipe 1001 into a package 100, wherein the cleaning of air from CO₂ and H₂O components and compression up to a bottom charge are performed. In this package, the process air, as a mixture of the cleaned atmospheric and recirculating air streams at the bottom charge pressure, is compressed from this pressure up to a higher rated level. A power required for atmospheric and process air compression is consumed from the electrical grid 2000 through a line 1002. The process air is further delivered through a pipe 1003 into a package 200. Here the following final compression with auto-refrigeration of said process air results in liquefying a lesser part of the process air and delivering a liquid air through a pipe 1004 at said bottom charge pressure into the storage 300, whereas a major part of the process air recirculates at the mentioned bottom charge pressure into said package 100 through a pipe 1005. Simultaneously with charging the LAES, a co-located LNG production plant 4000 is supplied with the pressurized NG from the main pipeline 3000 through a pipe 4001, as well as with the power from the grid 2000 (not shown). After cleaning in the pre-treatment unit 4002 the NG is directed through a pipe 4003 to the package 4004, wherein it is subjected to liquefaction. After depressurization of the produced LNG down to a given level, it is directed through a pipe 4005 into a storage package 4006, wherein it is stored. On-demand supplying the customers with the LNG product is performed from the package 4006 through a pipe 4007.

During discharging the LAES a liquid air is extracted from said storage 300 through a pipe 1006 and pumped under high pressure (HP) through the packages 400 and 500 and the pipes 1007 and 1008 into a discharged air recovery package 600. In the package 400 a part of cold thermal energy inherent in the HP liquid air stream is captured, resulting in re-gasification of HP liquid air. A rest of cold thermal energy inherent in the HP re-gasified air stream is captured in the package 500, resulting in pre-heating this air prior to its delivering into a package 600. Here the discharged air is expanded down to a medium-pressure (MP) in the HP air expander and used further as an oxidant for burning the NG delivered into a fueled prime mover through a pipe 1009 from the gas network 3000. The power outputs of said HP air expander and the fueled prime mover are conveyed as the first and second LAES on-demand power outputs to the grid 2000 through a line 1010. A low-pressure (LP) exhaust gas leaves the prime mover through a pipe 1011 and is delivered into said package 500. Here LP exhaust stream is cooled by the stream of HP re-gasified air and dehydrated with removing the condensed and frozen H₂O component through a pipe 1012. The dehydrated exhaust is delivered through a pipe 1013 into the package 700, wherein it is depressurized and additionally cooled in a LP exhaust expander. The power output of said LP exhaust expander is conveyed as the third LAES on-demand power output to the grid 2000 through a line 1014.

The dehydrated and depressurized exhaust stream is further directed through a pipe 1015 to the package 400, wherein it is decarbonized through deep cooling by the stream of the HP liquid air 1006. This process is accompanied by de-sublimating the CO₂ component, which is removed from the outgoing exhaust stream 1017 through a pipe 1016. A cold thermal energy of the decarbonized exhaust stream is further recovered for liquefaction of the NG in the package 800, whereupon the exhaust stream is released into atmosphere through a pipe 1018.

Of a total amount of pressurized NG fuel delivered into LAES facility during its discharging, only 5-15% is directed through the pipe 1009 to the fueled prime mover in the package 600, whereas the major part (˜95-85%) of delivered pressurized NG is directed through the pipes 4001 and 1019 to the packages 900 and 800 for pre-cooling and following conversion into a saleable LNG co-product. A NG destined for liquefaction is dried, purified and additionally compressed (if needed) in the NG pre-treatment package 4002. As mentioned above, a cold thermal energy required for pre-cooling and liquefaction of the pressurized NG is extracted from the separated CO₂ stream 1016 and decarbonized exhaust stream 1017. After depressurization of the produced LNG down to a given level, it is directed through the pipes 1020 and 4005 into a storage package 4006, wherein it is stored. On-demand supplying the customers with the LNG co-product is performed from the package 4006 through a pipe 4007. A reasonable amount of power required for operation of the NG pre-treatment package 4002 during discharging the LAES facility is delivered from this facility.

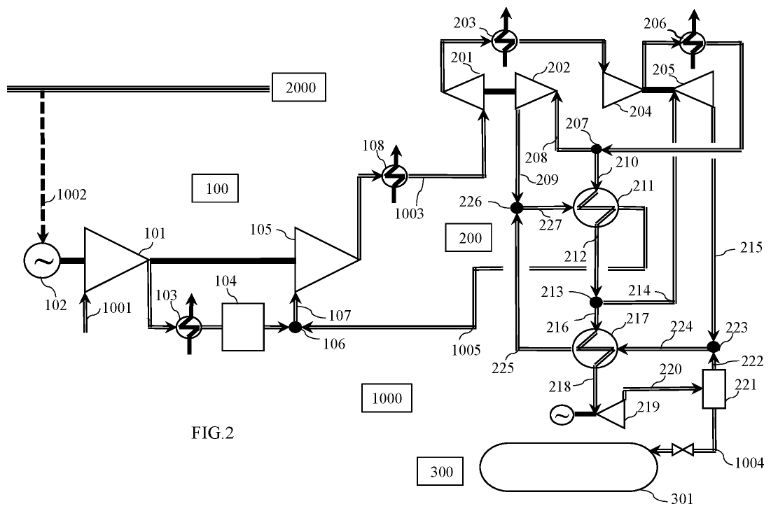

The charging of the LAES facility may be performed with use of one or two booster compressor-loaded turboexpanders. The latter approach has been proposed in the currently abandoned Pat. App. US2018/0066888 and shown in the FIG. 2. Here an initial compressing of the incoming atmospheric air up to a bottom charge pressure and process air up to a rated pressure is performed by the electrically driven compressors. Further sequential compressing the process air stream from the mentioned rated level up to a top charge pressure is performed by two booster compressors placed in tandem and driven by the turboexpanders operated in the charge pressures diapason between said top and bottom levels. The charging of the LAES facility may be performed in this case with use of said electric utility 2000 and the following equipment packages of the LAES facility 1000 with numeration of all entrances into packages and egresses from them identical to that in FIG. 1:

100—air compression and pre-treatment package;

200—air auto-refrigeration and liquefaction package; and

300—liquid air storage and pumping package.

According to the present invention, the package 100 is designed as two-stage compression train, wherein the first compressor 101 and second compressor 105 are driven by the common electric motor 102, connected to the grid 2000 through the line 1002. The air from atmosphere is delivered through a pipe 1001 into the first compressor 101 and pressurized up to a bottom charge pressure. A train is equipped with an intercooler 103 and an inter-cleaner (adsorber) 104 for capture of moisture and carbon dioxide from a pressurized atmospheric air. A stream of the cooled and cleaned air escaped the adsorber 104 is mixed at the point 106 with a stream 1005 of a recirculating air delivered at the same bottom charge pressure from a package 200. Mixing two air streams leads to forming a process air stream 107, which is further compressed up to the rated pressure level in the second compressor 105. A removal of compression heat in the intercooler 103 and aftercooler 108 is performed by an ambient air or water. If needed, the second compressor 105 may be designed in the intercooled configuration. From the aftercooler 108 the process air is delivered at the rated pressure into the package 200 through a pipe 1003.

Further compressing the process air stream up to the top charge pressure is sequentially performed in the booster compressors 201 and 204 driven by the warm and cold turboexpanders 202 and 205 with cooling the air after each compressor in the heat exchangers 203 and 206 accordingly. At said top charge pressure the process air stream is directed to the point 207, wherein it is divided into two streams 208 and 210. A lesser part of the process air (stream 208) is expanded down to the bottom charge pressure in said warm turboexpander 202 with an accompanied auto-refrigerating of expanded air stream 209. Most of the process air (stream 210) is delivered into a deep cooler 211, wherein a process air temperature is decreased substantially below 0° C. by the full stream of recirculating air 227. Downstream of the deep cooler 211 (point 213) a stream 212 of a deeply cooled process air is further divided into two parts (214 and 216). For the most part of the process air (stream 214) is expanded in said cold turboexpander 205 down to the bottom charge pressure with an accompanied auto-refrigerating of expanded air stream 215 down to a temperature significantly below a temperature of the stream 209. The rest 216 of the process air is additionally cooled by the first portion of recirculating air stream 224 and fully liquefied in the air liquefier 217 at the top charge pressure. The liquefied process air 218 is further directed to a generator-loaded turbine 219 or alternatively to the Joule-Thomson Valve, wherein it is expanded down to the bottom charge pressure with an accompanied final cooling of expanded air down to a bottom charge temperature. The bottom charge pressure is selected at a level exceeding an atmospheric pressure by 1-7 bar. The air separator 221 is used to separate the liquid and gaseous phases in the air stream 220 at the outlet of turbine 219. The liquid air stream 1004 is directed to the pressurized liquid air vessel 301 of the package 300, wherein it is stored between the charging and discharging of the LAES at the bottom charge pressure and temperature.

The gaseous air stream 222 is directed to the point 223, wherein it is mixed with a stream 215 of the process air coming from the cold turboexpander 205. This results in formation of the first portion 224 of the recirculating air stream at the bottom charge pressure. The first portion 224 of the recirculating air stream is further used for the additional cooling and liquefying of the rest 216 of the process air in the air liquefier 217. This leads to an increase in temperature of the stream 225 of the first portion of recirculating air outgoing from the liquefier 217. The stream 225 is mixed at the point 226 with a stream 209 of process air coming from the warm turboexpander 202, resulting in formation of the full recirculating air stream 227 at the bottom charge pressure. This stream 227 is further used for cooling the most 210 of process air in the deep cooler 211, resulting in an increase in temperature of the full recirculating air stream 1005 outgoing from the deep cooler 211. This recirculating air is further directed to the package 100 for said mixing with the pressurized atmospheric air stream at the point 106.

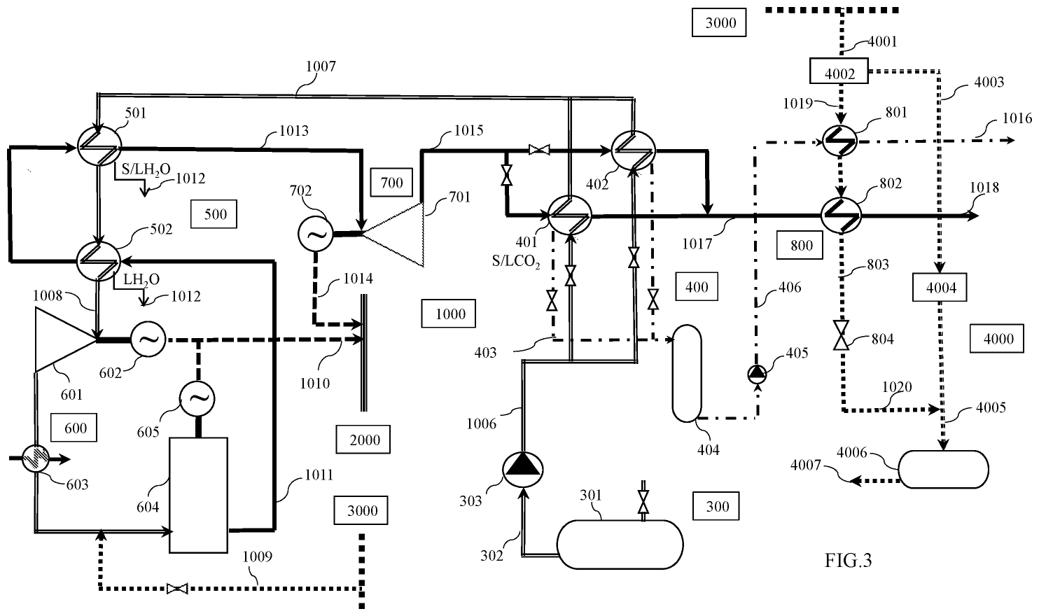

FIG. 3 shows schematically the third embodiment for discharging the LAES integrated with the fueled supercharged reciprocating internal combustion engine (RICE) and co-producing the on-demand power and liquefied natural gas (LNG), according to the invented method. Here the involved equipment packages are designated as:

300—liquid air storage and pumping package;

400—LAES exhaust decarbonization package;

500—LAES exhaust dehydration package;

600—discharged air recovery package equipped with the fueled supercharged RICE;

700—cold exhaust expander package; and

800—NG liquefaction package.

Operation of the LAES facility 1000 in discharge mode is performed as follows. A stream of liquid air 302 is extracted from the slightly pressurized storage vessel 301 and pumped by a pump 303 up to a top discharge pressure selected in the range between 40 and 200 bar. The pumped high-pressure (HP) liquid air stream is delivered through a pipe 1006 into a package 400 which is destined for re-gasifying this air and de-sublimation of CO₂ component in the stream of the depressurized LAES exhaust. This package consists of two heat exhangers 401 and 402 installed in parallel and being operated in turn in working and regeneration regimes.

The HP re-gasified air stream is further directed through a pipe 1007 into a package 500 which is destined for dehydration of the pressurized LAES exhaust and pre-heating the HP re-gasified air in the heat exchangers 501 and 502. In these heat exchangers the discharged air temperature is risen up to a level not exceeding 540° C. at the inlet of the package 600. The mentioned inlet temperature restriction makes possible to use the commercially available back-pressure steam turbine for partial expanding the superheated re-gasified air in the HP air expander 601 down to a rated medium pressure selected in the range from 2 up to 12 barA. The expander 601 is coupled with electric generator 602, converting mechanical work of the expander into the first part of the LAES electrical output and delivering this power into the grid 2000 through a line 1010. The discharged air partially expanded in the expander 601 is delivered through aftercooler 603 into the fueled supercharged RICE 604. Here this air is used as oxidant for lean-burning a NG fuel directed to the engine 604 through a pipe 1009 from the gas network 3000. A share of this NG stream is between 9 and 15% of total amount of the NG delivered into the LAES facility.

The engine 604 is loaded by the generator 605 and used to produce the second power output of the LAES facility delivered into the grid 2000 through a line 1010. Combustion of gaseous fuel in said RICE is accompanied by formation of the water (H₂O) vapor and gaseous carbon dioxide (CO₂) components in the stream of exhaust gas, which escapes the RICE through a pipe 1011 at a low-pressure (LP) of 3-5 barA and an enhanced temperature of 500-550° C. Under said pressure the LP exhaust from the RICE is directed into the package 500, wherein it is cooled down to −30÷−40° C. by the HP re-gasified air stream in the heat exchangers 502 and 501. This leads to practically complete dehydration of the pressurized exhaust stream upstream of the LP exhaust expander 701, resulting from condensing and draining over 98% (m/m) of the H₂O component amount in this exhaust stream through a pipe 1012 and following freezing over 1.7% (m/m) of the H₂O component in the heat exchanger 501. Since a volumetric water vapor content in the pressurized exhaust gas stream at the temperature of 1° C. does not exceed 0.2%, ice deposition on the tubing surface of the heat exchanger 501 during discharging the LAES does not lead to a marked increase in pressure drop. This makes possible to postpone the ice removal until starting a process of charging the LAES. During this process a compression heat from any air intercooler or aftercooler of compressor train may be used to melt the ice on the tubing surface of the cooler 501 with drainage of the formed liquid water through a coupled drainage device and pipe 1012. The dehydrated pressurized exhaust stream is further delivered through a pipe 1013 into the package 700 and expanded in the work-performing LP exhaust expander 701 coupled with the electric generator 702. This results in production of the third power output of the LAES facility delivered into the grid 2000 through a line 1014 and in cooling the depressurized exhaust stream down to −90÷−95° C.

A further deep cooling of the depressurized exhaust stream down to ˜−160° C. is performed by a stream of the HP liquid air in the heat exchangers of the package 400. Here the exhaust deep cooling is accompanied by de-sublimation of CO₂ component and its deposition on the tubing surface of the heat exchangers in the form of dry ice. Since a mass CO₂ content in the dewatered exhaust gas stream at the inlet of the package 400 lies in the range from 8 to 8.5%, a solid CO₂ deposition on the tubing surface of its heat exchangers may lead to a marked increase in pressure drop in the exhaust gas stream. To exclude a possibility for formation of intolerably thick layer of dry ice, a pair of the heat exchangers 401 and 402 may be installed. During discharging the LAES, the said heat exchangers are used in turn for de-sublimation of CO₂ component and its removal in a liquid state (heat exchanger cleaning). Whereas in one heat exchanger a cryogenic capture of CO₂ component from exhaust gases stream is performed and accompanied by formation of dry ice on its tubing surface, another heat exchanger is disconnected from the exhaust gas duct and liquid air pipe and is freeing from the solid CO₂.

The CO₂ is removed in liquid form through a pipe 403 to pressurized tank 404, for which purpose a shell of disconnected heat exchanger is pressurized up to pressure above triple point of 5.2 barA. Then an available waste heat stream (for example, a stream of cooling water from the air cooler 603) is directed into tubing part of this heat exchanger to fuse the dry ice on the outer surface of tubing part and convert it directly into a liquid CO₂. A CO₂ removal efficiency depends strongly on said bottom and top discharge air pressures and exceeds 98%. Prior to removal of the liquid CO₂ from the LAES, its cold thermal energy is recovered for pre-cooling the NG intended for liquefaction. For this purpose, the liquid CO₂ is extracted from a storage vessel 404, pumped by the pump 405 via a pipe 406 into the NG pre-cooler 801 and removed in liquid form from this heat exchanger and LAES via a pipe 1016.

At a temperature of −150±−170° C. the decarbonized exhaust stream is further directed through a pipe 1017 to the package 800, which is destined for co-production of the LNG at the LAES. A share of this NG stream is between 85 and 90% of total amount of the NG delivered into the LAES facility. The NG is directed under a pressure from gas network 3000 through the pipe 4001 into a pre-treatment unit 4002 of the co-located LNG plant 4000. In the pre-treatment unit 4002 the delivered NG is cleaned from the H₂O and CO₂ components and if needed may be additionally compressed up to a higher pressure in the range from 100 barA to 200 barA. Through a pipe 1019 the HP pre-treated NG is further directed into a heat exchanger 801, wherein it is pre-cooled by a stream of the liquid CO₂. Resulting from the following deep cooling of the HP pre-treated NG by the decarbonized exhaust stream in the heat exchanger 802, the NG is liquefied at said HP pressure and directed through a pipe 803 to the Joule-Thomson Valve 804. Here a pressure of the HP liquefied NG is reduced down to a rated LP value, at which the liquefied natural gas (LNG) is delivered into the storage tank 4006 through the pipes 1020 and 4005. From 0.55 to 0.85 ton/h of LNG per each MWh of the electrical energy may be co-produced in the package 800 of the LAES facility equipped with the supercharged RICE, as the fueled prime mover; in so doing, the higher is a pressure of the NG delivered from pre-treatment unit 4002 into the liquefier 802, the higher is the LNG co-production rate of the LAES facility. The exhaust stream escapes the NG liquefier 802 through a pipe 1018 at a temperature near the atmospheric value.

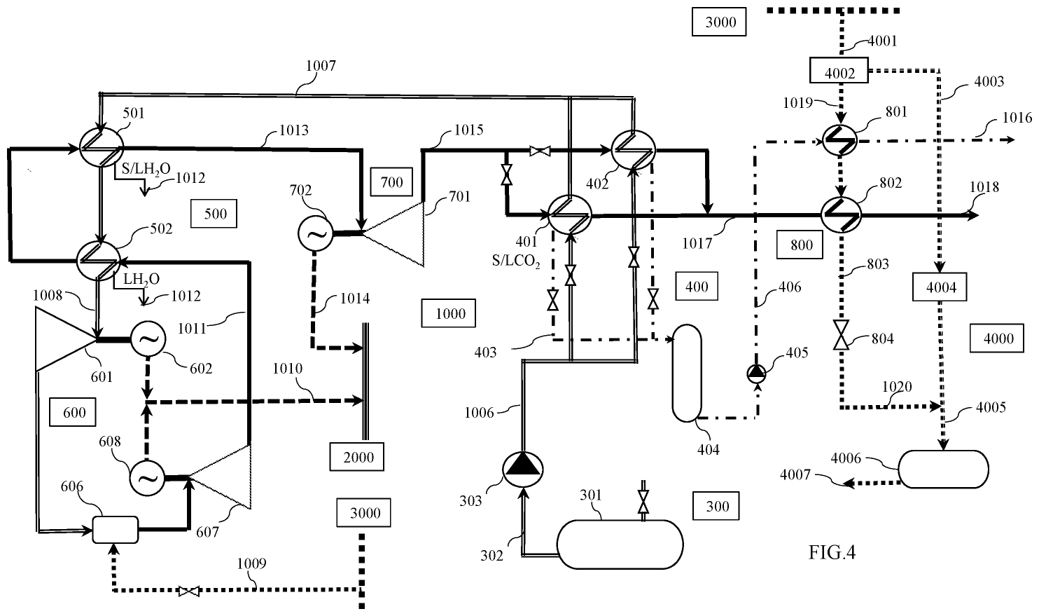

FIG. 4 shows schematically the fourth embodiment for discharging the LAES integrated with the fueled rotating ICE and co-producing the on-demand power and liquefied natural gas (LNG), according to the invented method. Here the involved equipment packages are designated as:

300—liquid air storage and pumping package;

400—LAES exhaust decarbonization package;

500—LAES exhaust dehydration package;

600—discharged air recovery package equipped with fueled industrial rotating expander;

700—cold exhaust expander package; and

800—NG liquefaction package.

Operation of the LAES facility 1000 in discharge mode is performed much as it has been described above, as applied to the LAES integrated with the fueled supercharged RICE. The sole difference is a process of the discharged air recovery in the package 600, wherein the fueled industrial rotating expander is used instead of the mentioned fueled supercharged RICE. Presently there are not commercially available Brayton cycle gas turbine with the separate shafts for compressor and expander. Therefore, in the present embodiment of the invention a fueled prime mover is exemplified by a fueled industrial rotating expander 607 integrated with a pre-installed combustion chamber 606. Considering the existing restrictions imposed on the inlet temperature and pressure in the industrial expanders, a medium-pressure of re-gasified air at the outlet of HP re-gasified air expander 601 and at the inlet of the combustion chamber 606 is set at a level not exceeding 25 barA, whereas a temperature of combustion gases at the inlet of the industrial rotating expander 607 should not exceed 760° C. To reach this temperature, an amount of the NG delivered into the combustion chamber 606 may be not more than 5-7% of total amount of the NG delivered into the LAES facility.

The HP re-gasified air expander 601 with coupled electric generator 602 provide the first power output of the LAES facility, whereas the expander 607 is loaded by the generator 608 and used to produce the second power output of the LAES facility. Both the power outputs are delivered into the grid 2000 through a line 1010. Burning the gaseous fuel in the combustion chamber 606 is accompanied by formation of the water (H₂O) vapor and gaseous carbon dioxide (CO₂) components in the stream of exhaust gas, which escapes the expander 607 at a low-pressure (LP) pressure of 3-5 barA and an enhanced temperature of 500-600° C. through a pipe 1011. Under said pressure the LP exhaust from the expander 607 is directed into the package 500, which is used to pre-heat the HP re-gasified air upstream of the expander 601 and to cool and dehydrate the LP exhaust upstream of the expander 701. This expander together with coupled electric generator 702 provide the third power output of the LAES facility, delivered into the grid 2000 through a line 1014. A dehydrated and depressurized exhaust is further deeply cooled by the incoming liquid air, decarbonized and used together with the separated CO₂ for pre-cooling and liquefaction of the NG delivered from the pre-treatment unit of the co-located LNG plant. A specific LNG co-production rate at the LAES facility with a fueled industrial rotating expander lies in the range from 1.2 to 1.7 ton/h per each MW of the LAES power output and significantly exceeds this value for the LAES equipped with the fueled supercharged RICE. This is is because at the same discharge power output of these two LAES facilities an exhaust flow-rate of the LAES with a fueled industrial rotating expander is much higher owing to the moderate pressure and temperature of the combustion gases at the outlet of combustion chamber 606.

### INDUSTRIAL APPLICABILITY

The calculated performances of LAES facility with zero-carbon emitting power augmentation and co-production of LNG are presented below. The selected prime mover at such LAES facility is exemplified by the fueled supercharged RICE. Charging the LAES facility is first performed with use of the commercially available electrically driven fresh and process air compressors and then by two turbo expander-compressors of the air auto-refrigeration cycle (see FIG. 2). During charging the LAES, a liquid air is produced and stored at 6.7 barA. Compression of the fresh air up to 6.7 barA is performed by the one-stage uncooled compressor, whereas a further compression of the process air up to 33 barA is performed in the one-stage uncooled process air compressor. Two booster compressors installed in tandem and driven by the warm and cold turbo-expanders provide a further increase in a process air pressure up to the final top charge pressure of 61.7 barA. The main calculated data of the LAES facility in charge mode are presented in the Table 1. Here the following designations are used: PLA pressure of liquid air produced; G_{PA} and G_{LA}—flow-rates of process (mixed) air and liquid air produced; W_{CH}—electric power consumed by the LAES facility, in view of power produced by liquid air expander; ALR=(G_{LA}/G_{PA})×100%—air liquefaction ratio; and ω_{CH}=1000×W_{LAES-CH}/(G_{LA}×3.6)—specific external power consumed for air liquefaction.

As shown in the FIG. 3, a fueled augmentation of the LAES discharge power is performed through integration between LAES facility and a fueled supercharged RICE. The latter is exemplified by the gas engine (GE) designed for producing 9730 kW of electrical power at Heat Rate of 7,779 kJ/kWh or 46.3% of electrical efficiency. The engine is supercharged with a

TABLE 1

Parameters

| | P_{LA} | G_{PA} | G_{LA} | ALR | W_{CH} | ω_{CH} |
|---|---|---|---|---|---|---|
| Units | barA | kg/s | kg/s | % | MWe | kWh/ton |
| Data | 6.7 | 95.1 | 15.1 | 15.9 | 23.56 | 433 |

stored (combustion) air at the flow-rate of 15.1 kg/s, pressure of 3.92 barA and temperature of 45° C. During energy storage discharge the GE is supplied with a minor part (10-13%) of the NG fuel delivered into the LAES facility and assumed for simplification of calculation as pure methane (CH4) with LHV=48,632 kJ/kg. Lean-burning this fuel in the GE leads to formation of the H₂O and CO₂ components in the stream of exhaust gases escaped the GE at the pressure of 3.6 barA and temperature of 535° C. The flow-rates of combustion air (G_{CA}), fuel (G_{FUEL}) and exhaust gases (G_{EXH}), as well as the mass concentration of H₂O and CO₂ components at the GE outlet are presented in the Table 2 below.

As confirmed by the leading OEM, the commercially available back-pressure steam turbine may be used as the high-pressure (HP) superheated air expander. As applied to the discussed industrial application, it is assumed that after re-gasifying the pumped liquid air in the

TABLE 2

| | Parameters | | | | |
|---|---|---|---|---|---|
| | G_{CA} | G_{FUEL} | G_{EXH} | H₂O | CO₂ |
| Units | kg/s | kg/s | kg/s | %(m/m) | %(m/m) |
| Data | 15.1 | 0.432 | 15.532 | 6.26 | 7.65 |

package 400 and superheating the HP re-gasified air above 500° C. in the package 500 (see FIG. 3), air pressure may be reduced from 140 barA down to 3.95 barA in the work-performing HP expander coupled with its own electric generator. At the mentioned LP pressure, the re-gasified air is directed to the GE, wherein it is used as oxidant for lean-burning a fuel in this engine. Transferring a heat from the pressurized GE exhaust to the re-gasified HP air in the package 500 provides a cooling of the GE exhaust down to −33° C. As mentioned above, this leads to practically complete dehydration of the pressurized exhaust stream upstream of the LP exhaust expander (see package 700). A power produced by this expander, as well as by the HP air expander and GE is delivered into the grid as on-demand power output of the LAES facility.

Reducing a temperature of the GE exhaust expanded in the LP expander and transferring a thermal energy from the depressurized GE exhaust to the liquid HP air being re-gasified in the package 400 provide a deep cooling of the GE exhaust at the outlet of this package down to ˜−160° C. As mentioned above, this leads to cryogenic removing 98.5% of the CO₂ component from the GE exhaust. A cold thermal energy of the separated CO₂ and decarbonized GE exhaust is further used in the package 800 for pre-cooling and liquefying the greater part (from 85 to 90%) of the NG delivered into the LAES facility. It is assumed that the package 800 is supplied with NG from the pre-treatment unit of the co-located LNG plant 4000 at at pressure of at least 70 barA (alt. A), which may be increased in the pre-treatment package up to 100 barA (alt. B) and 200 barA (alt. C) for an increase in LNG co-production by 15-45%. A HP NG is pre-cooled and fully liquified in the heat exchangers 801 and 802, reduced in pressure down to 4 barA in the Joule-Thomson valve 804 and delivered into storage 4006 as a saleable co-produced LNG. Thereby, with an increase in the NG pressure at the inlet of the heat exchanger 802 from 70 to 200 barA, an amount of the LNG co-produced at the LAES facility is increased from 0.55 to 0.85 ton/h per each MW of the LAES power output.

The main calculated data of the LAES facility in the discharge mode for three alternative pressures of HP NG are presented in the Table 3, wherein the following designations are used: W_{HP-EXP}—electric power produced by the HP air expander; W_{GE}—electric power produced by the gas engine; W_{LP-EXP}—electric power produced by the LP exhaust expander; W_{P-LA}—electric power consumed by the liquid air pump; W_{P-CO2}—electric power consumed by the CO₂ pump; W_{HP-EXP}+W_{GE}+W_{LP-EXP}−W_{P-LA}−W_{P-CO2}=W_{DCH}—LAES electric power in the discharge mode; ω_{DCH}=W_{DCH} (G_{LA}×3.6) specific discharge power; RTE_{LAES}=(W_{DCH}/W_{CH})×100% —round trip efficiency of the LAES facility; P_{HP-NG}—high-pressure of the NG liquefied; G_{LNG}—LNG co-production rate; G_{LNG}/W_{DCH}—specific LNG co-production rate of the LAES facility; (G_{LNG}/(G_{LNG}+G_{FUEL}))×100%—a share of the NG liquefied at the LAES facility; (998.4-39.5×G_{LNG})×G_{LNG}=W_{LNG}—power equivalent of the LNG co-produced (determined with regard to the Tractebel Engineering recommendations); W_{NGC}—electric power consumed by the HP NG compressor; W_{DCH}+W_{LNG}−W_{NGC}=W_{TOT}—total recasted electric power produced during discharging the LAES; RTE_{TOT}=(W_{TOT}/W_{CH})×100%—total recasted round trip efficiency of the LAES facility; G_{CO2}—amount of CO₂ removed; and η_{CO2}—efficiency of CO₂ removal.

The presented results of the LAES data calculation confirm the expected merits of the invented method of operating the LAES facility with a fueled supercharged RICE, namely: a) an increase in RTE value from RTE_{LAES}=72.5%, which may be achieved through a partial recovering the waste energy streams at the LAES facility, up to RTE_{TOT}=96-98% obtained through a total recovering the mentioned waste energy streams; b) a possibility of simultaneous co-producing the on-demand power and the LNG in relationship from 0.55 up to 0.85 ton/MWh; c) a possibility to provide practically zero carbon emitting fueled augmentation of the LAES on-demand power output, resulting from an extremely high (˜98.5%) efficiency of cryogenic capture of the CO₂ emissions from the GE prime mover and removal of ˜18000 t/y of CO₂ in liquid form from the LAES exhaust; and d) a possibility to provide zero carbon footprint for annual co-producing from 40 to 60 kton LNG at the LAES facility, resulting in annual obviating at least 11400 ton of CO₂ emissions, which otherwise would be inevitable in the production of the same amount of LNG at the GE-driven co-located LNG plant.

It should be noted that the term “comprising” does not exclude other elements or steps and “a” or “an” do not exclude a plurality. It should also be noted that reference signs in the claims should not apparent to one of skill in the art that many changes and modifications can be affected to the above embodiments while remaining within the spirit and scope of the present invention.

TABLE 3

| | | Alternative | Alternative | Alternative |
|---|---|---|---|---|
| | | A | B | C |
| | | P_{HP-NG} = | P_{HP-NG} = | P_{HP-NG} = |
| Parameter | Unit | 100 barA | 200 barA | 70 barA |
| W_{HP-EXP} | MWe | 6.86 | 6.86 | 6.86 |
| W_{GE} | MWe | 9.73 | 9.73 | 9.73 |
| W_{LP-EXP} | MWe | 0.82 | 0.82 | 0.82 |
| W_{P-LA} | MWe | 0.31 | 0.31 | 0.31 |
| W_{P-CO2} | MWe | 0.01 | 0.01 | 0.01 |
| W_{DCH} | MWe | 17.09 | 17.09 | 17.09 |
| ω_{DCH} | kWh/ton | 314 | 314 | 314 |
| RTE_{DCH} | % | 72.5 | 72.5 | 72.5 |
| G_{LNG} | ton/h | 10.8 | 13.7 | 9.4 |
| W_{NGC} | MWe | 0.18 | 0.77 | 0 |
| W_{LNG} | MWe | 6.18 | 6.27 | 5.88 |
| W_{TOT} | MWe | 23.08 | 22.58 | 22.97 |
| RTE_{TOT} | % | 98.0 | 95.9 | 97.5 |
| G_{LNG}/ | ton/MWh | 0.64 | 0.84 | 0.55 |
| W_{DCH} | | | | |
| G_{LNG}/ | % | 87.4 | 89.8 | 85.8 |
| (G_{LNG} + G_{FUEL}) | | | | |
| G_{CO2} | ton/h | 4.22 | 4.22 | 4.22 |
| η_{CO2} | % | 98.5 | 98.5 | 98.5 |

1. A method for operating a liquid air energy storage (LAES), comprising in combination:
charging the LAES through consuming a low-demand power from a co-located renewable energy source or a grid for after-cooled compressing a process air, as a mixture of a pressurized pre-treated feed air and a recirculating air, further boost after-cooled compressing said process air, work expanding and accompanied refrigerating a recirculating part of the process air, recovering said work of expanding for powering the boost compressing and using a refrigerated recirculating air for in-direct cryogenic cooling a rest of the process air, and further depressurizing, partial liquefying and separating said cryogenically cooled rest of the process air into a liquid air and a cold vapor with combining the refrigerated recirculating air and said cold vapor;
storing a liquid air in a storage tank;
delivering a natural gas (NG) into the LAES;
discharging the LAES through producing and delivering an on-demand power into the grid by means of pumping the liquid air from the storage tank, sequential re-gasifying said liquid air and heating a re-gasified air by a LAES exhaust with further work partial expanding the re-gasified air in a power block and recovering the expanded air as an oxidant for a burning of a minor part of said delivered NG in a fueled prime mover being used in said power block for augmentation of the LAES on-demand power and selected from a group consisting of, but not limited to an industrial rotating expander and a supercharged reciprocating internal combustion engine (RICE);
using a waste thermal energy of the LAES exhaust leaving the power block at a pressure and an enhanced temperature for said heating the re-gasified air, resulting in cooling and associated dehydrating said LAES exhaust;
using a waste pressure energy of the LAES exhaust through work expanding and further cooling said LAES exhaust, resulting in forming a dehydrated and depressurized LAES exhaust;
using a part of a cold thermal energy derived from re-gasifying the liquid air for cryogenic cooling a dehydrated and depressurized LAES exhaust, resulting in de-sublimating and separating a carbon dioxide (CO₂) component formed by the NG burning in said fueled prime mover and in forming a cooled decarbonized LABS exhaust; and
wherein:
a cold thermal energy of the cooled decarbonized LAES exhaust is used for liquefying a remainder part of the NG delivered into the LAES and forming a liquefied NG (LNG) as a saleable co-product of said LAB'S;
an amount of said LNG co-produced is dependent on a type of the fueled prime mover and is increased through selecting the industrial rotating expander, as said fueled prime mover, all other factors being equal; and
an amount of said LABS on-demand power is dependent on the type of the fueled prime mover and is increased through selecting the supercharged RICE, as said fueled prime mover, all other factors being equal.

2. The method for operating the LABS, as in claim 1, further comprising the following processes conducted in tandem in an air stream from the storage tank during producing the on-demand power by the LABS:
pumping the liquid air from the storage tank, resulting in forming a high-pressure (HP) liquid air;
heating the HP liquid air by the dehydrated and depressurized LAES exhaust leaving a low-pressure (LP) exhaust expander, resulting in forming a HP re-gasified air;
heating the HP re-gasified air by a LP LAES exhaust leaving the fueled prime mover;
partial expanding the HP re-gasified air in a HP air expander, resulting in producing a first part of the LAES on-demand power and in forming a medium-pressure (MP) re-gasified air at the outlet of the HP air expander; and
recovering the MP re-gasified air in the fueled prime mover for oxidizing 5-15% of the delivered NG in said fueled prime mover, resulting in producing a second part of the LAES on-demand power by the fueled prime mover and releasing a stream of the LP LAES exhaust from said power block.

3. The method for operating the LAES, as in claim 2, further comprising the following processes conducted in tandem in a stream of the LP LAES exhaust leaving the power block during producing the on-demand power by the LAES:
cooling said LP LAES exhaust by the HP re-gasified air, resulting in condensing and freezing a water (H₂O) component and forming a dehydrated LP LAES exhaust;
expanding the dehydrated LP LAES exhaust in the LP exhaust expander, resulting in further reducing in temperature of the dehydrated and depressurized, LAES exhaust and producing a third part of the LAES on-demand power;
final cryogenic cooling the dehydrated and depressurized LAES exhaust leaving the LP exhaust expander by the HP liquid air, resulting in de-sublimating and separating the CO₂ component from the dehydrated and depressurized LAES exhaust and forming the cooled decarbonized LAES exhaust;
pressurizing, fusing and pumping a separated CO₂ component;
using a cold thermal energy of the separated CO₂ component for pre-cooling 85-95% of the NG delivered into the LAES and pre-treated prior to said pre-cooling;
using the cold thermal energy of said cooled decarbonized LAES exhaust for liquefying a pre-cooled NG and forming the LNG, as the LAES co-product.

4. The method for operating the LAES, as in claim 3, wherein said de-sublimating the CO₂ component provides reducing a CO₂ content in the dehydrated and depressurized LAES exhaust at least by 98.5%.

5. The method for operating the LAES, as in claim 3, further comprising the following processes conducted in tandem in a stream of the NG delivered for liquefying at the LAES:
supplying a NG pre-treatment unit with 85-95% of the NO delivered into the LAES;
removing the potentially freezable components from the NG in the pre-treatment unit and compressing said NG up to a selected high pressure (HP), resulting in forming a HP pre-treated NO stream;
using the cold thermal energy of said separated CO₂ component separated from the dehydrated and depressurized, LAES exhaust for pre-cooling said HP pre-treated NG stream, resulting in forming a HP pre-cooled NG stream;
using the cold thermal energy of the decarbonized LAES exhaust for liquefying the HP pre-cooled NG stream, resulting in forming a HP liquefied NG stream; and
expanding the HP liquefied NG stream, resulting in forming a low-pressure (LP) LNG, as the LAES co-product, at a rate of 0.5-1.7 ton/h per each MW of the LAES on-demand power, depending on the type of the fueled prime mover selected for installation at the LAES.

6. The method for operating the LAES, as in claim 5, wherein removing the potentially freezable components from the NG subjected to liquefying at the LAES is performed in the pre-treatment unit built into a NG liquefaction plant co-located with the LAES.

7. The method for operating the LAES, as in claim 6, wherein at least a part of the LAES on-demand power is used for operating the co-located NG liquefaction plant, whereas the LNG co-produced at the LAES is used for increasing a production yield of said co-located NG liquefaction plant.
